(19) United States
(12) Patent Application Publication
(10) Pub. No.: US 2005/0035865 A1
(43) Pub. Date: Feb. 17, 2005

(54) Pet locator system

(76) Inventors: Edward C. Brennan, Pembroke, MA (US); Scott Almader, Pembroke, MA (US); James Muldoon, Pembroke, MA (US)

Correspondence Address: ASHKAN NAJAFI, P.A., 6817 SOUTHPOINT PARKWAY, SUITE 2301, JACKSONVILLE, FL, 32216, US

(21) Appl. No.: 10/637,857

(22) Filed: Aug. 11, 2003

(51) Int. Cl. G08B 23/00

(52) U.S. Cl. 340/573.3; 340/539.13

(57) ABSTRACT

An animal locating system including a collar unit including a wireless transceiver for selectively emitting encoded signals to a portable fence unit and to identify when an animal has wandered beyond a predetermined boundary. The system further includes a remote unit including a transmitting mechanism for selectively sending an encoded signal to the collar unit and for notifying an animal that an undesired act has been performed. The portable fence unit is selectively positionable for determining a predetermined boundary within which an animal may wander. The system further includes a third party service unit including a locating mechanism for communicating with a GPS mechanism of the collar unit so that a location of an animal can be determined. The third party service unit also communicates with a transceiver mechanism of the collar unit for determining a location of an animal when same has wandered beyond a predetermined boundary.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a pet locator system and, more particularly, to a pet locator system including a portable fence unit for selectively redefining boundary limits for a pet.

2. Prior Art

Conventional electronic animal containment systems have a subterranean transmission antenna shaped to define fixed boundaries of a confinement area. The transmission antenna transmits a unique electromagnetic signal, which is received by a collar transceiver having a radio frequency receiver. The collar transceiver is typically attached to the neck of an animal and is used to stimulate that animal to, among other things, encourage or discourage certain behavior such as movement.

Electronic animal containment systems that can be installed with minimal disruption of the landscape and readily reconfigured to redefine the confinement area are in great demand. In the current practice, the installation of a subterranean transmission antenna requires excavation of the confinement area boundary which can entail disruption of plant root systems, damaging surrounding grass, flower beds and the like. Additionally, obstacles such as trees, concrete walkways, and driveways may hinder the installation.

Beyond installation difficulties, the fixed location of the subterranean transmission antenna inhibits future alteration of the confinement area. Redefinition of the confinement area is advantageous, as confinement needs change with, for example, the introduction of new animals or changes to the landscape. Moreover, at present, electronic animal containment systems are generally permanent to the location on the property in which the antenna is installed. This permanency denies its availability for use when traveling and can necessitate the purchase of an additional system upon relocation given the impracticality of excavating and salvaging an installed system.

Consequently, satellite global positioning systems that can be used to dynamically define a confinement area and also track animals are desirable for use in animal containment systems. An animal containment system based on the GPS obviates the need for the fixed subterranean antenna and eliminates the aforementioned disadvantages of the buried antenna.

### BRIEF SUMMARY OF THE INVENTION

In view of the foregoing background, it is therefore an object of the present invention to provide a pet locator system including a portable fence unit for selectively redefining boundary limits for a pet. These and other objects, features, and advantages of the invention are provided by an animal locating system including a collar unit including a wireless transceiver for selectively emitting encoded signals to identify when an animal has wandered beyond a predetermined boundary. The collar unit further includes a notification mechanism communicating with the transceiver and for dissuading an animal from wandering beyond a predetermined boundary.

The notification mechanism includes a power source, a microprocessor connected to the power source, and a transformer connected to the power source and the microprocessor. The transformer supplies electric shock to an animal when the microprocessor sends a signal thereto for indicating that an animal has wandered beyond a predetermined boundary. The collar unit further includes a GPS mechanism connected to the transceiver and for identifying a location of an animal after same has wandered beyond a predetermined boundary.

The system further includes a portable remote unit including a transmitting mechanism for selectively sending an encoded signal to the collar unit and for notifying an animal that an undesired act has be n performed. The system further includes a portable fence unit including a housing having a general pyramid shape. The fence unit includes a plurality of elongate antennas spaced apart from each other and extending outwardly from the housing. The portable fence unit further includes a potential mechanism for determining the level of voltage to be supplied by the notification mechanism to an animal. Advantageously, the portable fence unit is selectively positionable for determining a predetermined boundary within which an animal may wander.

The system further includes a third party service unit including a locating mechanism for communicating with the GPS mechanism so that a location of an animal can be determined. The third party service unit also communicates with the transceiver mechanism for determining a location of an animal when same has wandered beyond a predetermined boundary.

The notification mechanism preferably includes electrical contacts connected to the transformer. The transmitting mechanism preferably includes an antenna, a transmitter connected to the antenna, a microprocessor connected to the transmitter, and a power source connected to the microprocessor. The potential mechanism preferably includes an antenna wire, a transmitter connected to the antenna wire, a microprocessor connected to the transmitter, and a potentiometer connected to the microprocessor. The locating mechanism preferably includes a transmitter, a CPU connected to the transmitter, a wide area network connected to the CPU, and a database connected to the CPU for keeping track of a location of an animal.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing a pet locator, in accordance with the present invention;

FIG. 2 is an enlarged cross-sectional view taken along line 2-2 of the fence unit shown in FIG. 1;

FIG. 3 is an enlarged cross-sectional view of an animal collar taken along line 3-3 of the collar unit shown in FIG. 1;

FIG. 4 is a schematic block diagram illustrating the primary physical elements and associated operating environments of the present invention; and

FIG. 5 is a schematic block diagram illustrating the primary physical elements of a third party GPS locating system for determining the location of a pet.

### DETAILED DESCRIPTION OF THE INVENTION

The present invention will now be described more fully hereinafter with reference to the accompanying drawings, in which a preferred embodiment of the invention are shown. This invention may, however, be embodied in many different forms and should not be construed as limited to the embodiment set forth herein. Rather, this embodiment is provided so that this application will be thorough and complete, and will fully convey the true scope of the invention to those skilled in the art.

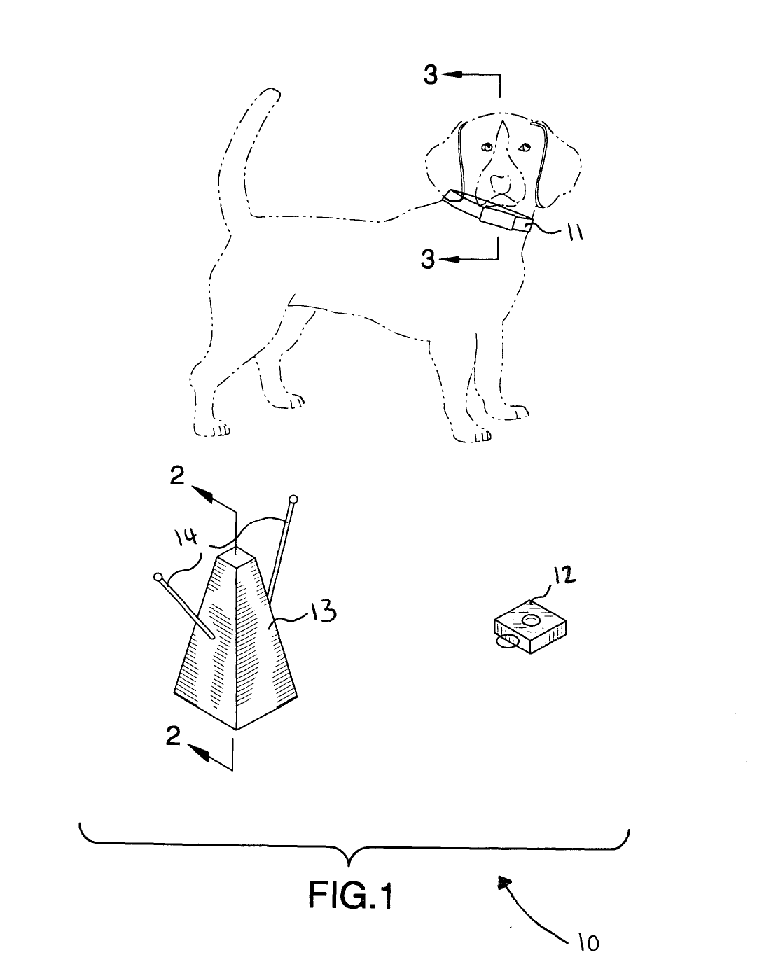

The system of this invention is referred to generally in FIG. 1 by the reference numeral 10 and is intended to provide a pet locator-system. It should be understood that the system 10 may be used to locate various animals and, therefore, should not be construed as having limited applicability to any particular type of animal.

The system 10 includes a portable collar unit 11 removably positionable onto an animal, a portable fence unit 13 selectively positionable for defining a predetermined boundary within which the animal may wander, a remote unit 12 for selectively supplying shock to an animal even though same has not wandered beyond the predetermined boundary, and a third party GPS service 36 (shown in FIG. 5) for determining the location of an animal after it has wandered beyond the predetermined boundary.

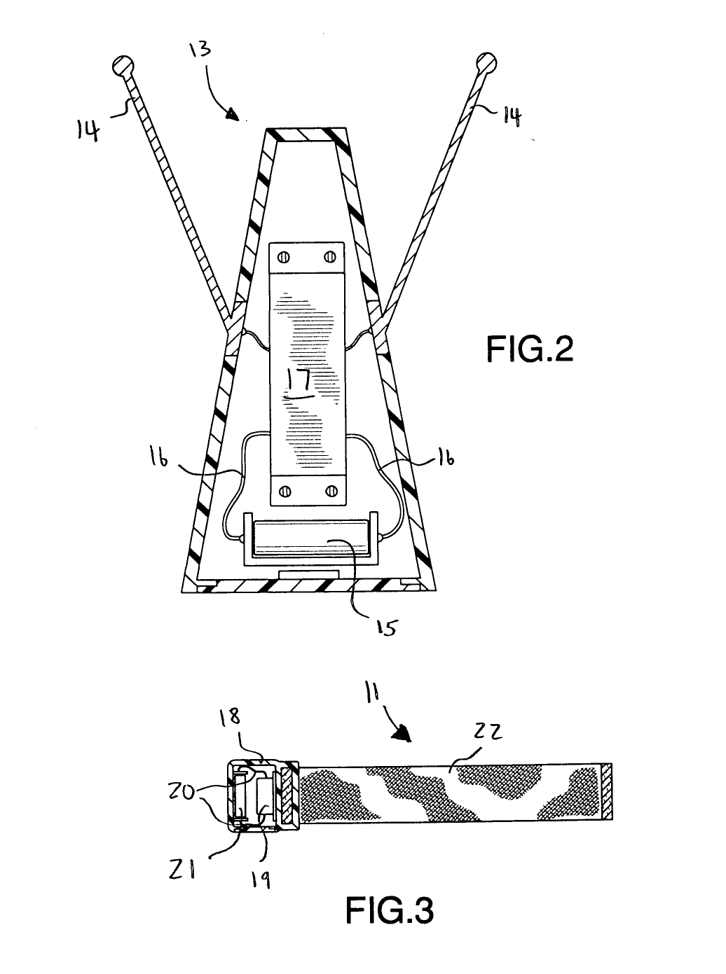

Now referring to FIG. 2, the portable fence unit 13 includes a generally pyramid-shaped housing having a substantially planar bottom surface so that the unit 13 can be readily placed on a ground surface. Th unit 13 includes a plurality of elongate antennas 14 spaced apart from each other and extending outwardly from the housing in substantially opposed directions. Each antenna 14 is electrically connected to a potentiometer 17, as well known in the industry. Such a potentiometer 17 serves as a voltage divider, which includes a resistor or series of resistors provided with taps at certain points and used to provide various potential differences from a single power source 15. Such a power source is electrically connected to the potentiometer 17 via a pair of wires 16.

Advantageously, an operator of the system 10 may establish a predetermined boundary by simply positioning the portable fence unit 13 at a desired location. This effectively eliminates the need to perform complicated installations of conventional boundary markers, as typically required in prior art systems. For example, the portable fence unit 13 may be positioned within a garage or outside of a dwelling by simply picking it up and moving it to the desired location without having to route elongate cables. Of course, the system 10 may include a plurality of fence units 13, which can be positioned at predetermined locations, as desired by a user.

Now referring to FIG. 3, the portable collar unit 11 includes an elongate and flexible band portion 22 that can be fitted around an animal's neck, for example. Of course, such a collar unit may also be fitted around an animal's ankle or other body part, if desired. The opposed end portions of the band 22 are attachable to each other via a buckle 18. Such a buckle includes a power source 19 connected to a transformer 21 via a pair of electrical wires 20. Such wires supply power to the transformer 21 for shocking the animal when it wanders beyond a predetermined boundary, as defined by the portable fence unit 13.

The buckle 18 may be provided to permit the collar unit 11 to be opened and closed for securing the band 22 around the neck or body of the animal to be tracked or located. Such a buckle 18 may be electrically integrated with the collar unit 11 and the electronic circuitry, e.g. constructed with an interlock, such that initial mating of the buckle 18 will activate operation of the transceiver 23. Any subsequent opening of the buckle 18 may initiate an alarm message to the third party service provider 36 indicating deactivation of the transceiver 23 except when a message sent to the transceiver 23 by the third party service provider 36 caused a previous, intentional deactivation.

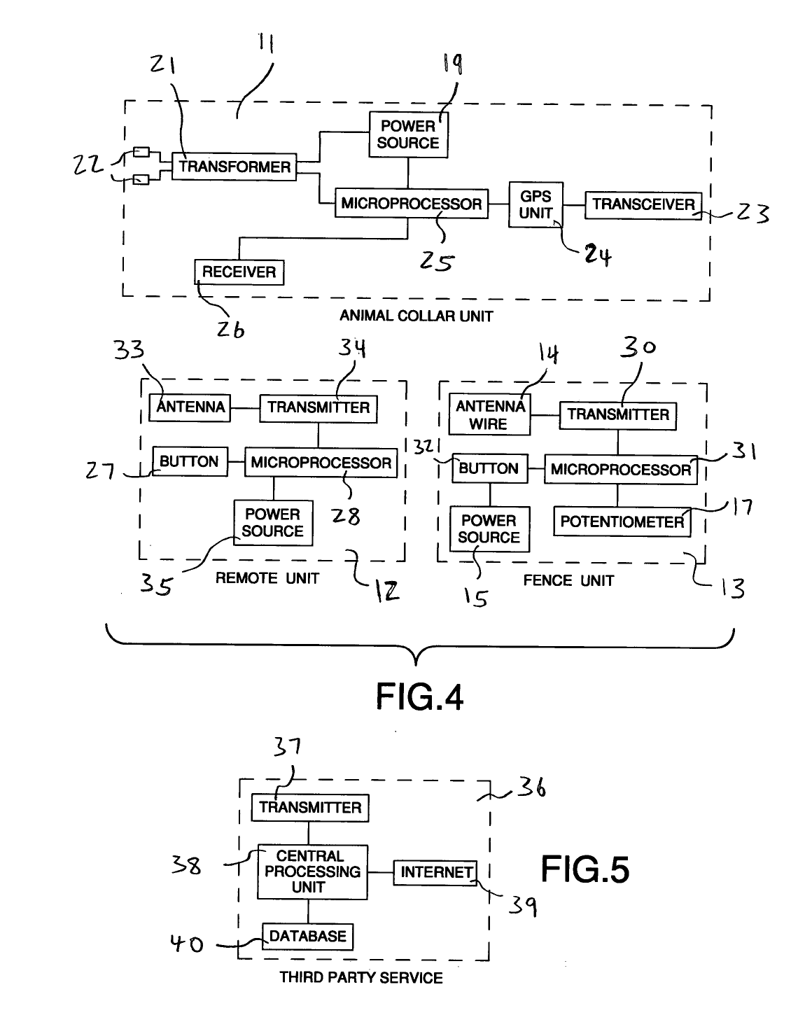

Now referring to FIG. 4, the portable collar unit 11 includes a pair of electrical contacts 22 connected to the transformer 21 and for supplying an electrical shock to an animal upon receiving an encoded signal from either the remote unit 12 or fence unit 13. Accordingly, the collar unit 11 includes a wireless receiver 26 and microprocessor connected thereto for receiving and decoding such encoded signals, respectively. Such signals may be transmitted to the collar unit 11 when the animal wanders or stays beyond a predetermined boundary, as defined by the portable fence unit 13. If the animal does not respond to the first electrical shock, a second or third more potent but still humane shock level would be used to deter the animal from leaving the predetermined boundary.

Contemporaneously, the transceiver 23 in the collar unit 11 transmits periodic encoded signals to the remote and fence units 12, 13, respectively, for indicating whether the animal has wandered outside the predetermined boundary. If such signals weaken and drop below a predetermined threshold, the circuitry in the collar unit 11 will switch to a GPS beacon mode. In particular, the microprocessor 25 coupled to the GPS unit 24 will begin communicating with the transceiver 23 to locate the animal via a conventional Internet-based, or wide-area network, third party monitoring service provider 36, as well known in the industry.

Such a conventional third party service provider 36 preferably includes a transmitter 37 coupled to a CPU 38 that is coupled to a database 40 and a wide-area network 39, such as the Internet, for example. It is noted that various third party service providers having alternate embodiments may be employed by the present invention 10, without departing from the true scope of the system 10.

The remote unit 12 includes an antenna 33 coupled to a transmitter 34 that is coupled to a microprocessor 28. Such a microprocessor is coupled to an on/off button 27 and a power source 35 for selectively supplying power to the unit 12. The portable fence unit 13 includes an antenna wire 14 coupled to a transmitter 30 that is coupled to a microprocessor 31. Such a microprocessor is coupled to an on/off button 32 and a potentiometer 17. A power source is coupled to the on/off button 32 for selectively supplying power to the unit 13.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

1. An animal locating system comprising:
a collar unit including a wireless transceiver for selectively emitting encoded signals to identify when an animal has wandered beyond a predetermined boundary, said collar unit further including notification means communicating with said transceiver and for dissuading an animal from wandering beyond a predetermined boundary, said collar unit further including GPS means connected to said transceiver and for identifying a location of an animal after same has wandered beyond a predetermined boundary;
a portable remote unit including transmitting means for selectively sending an encoded signal to said collar unit and for notifying an animal that an undesired act has been performed;
a portable fence unit including potential means for determining the level of voltage to be supplied by said notification means to an animal, said portable fence unit being selectively positionable for determining a predetermined boundary within which an animal may wander; and
a third party service unit including locating means for communicating with said GPS means so that a location of an animal can be determined, said third party service unit communicating with said transceiver means for determining a location of an animal when same has wandered beyond a predetermined boundary.

2. The system of claim 1, wherein said notification means comprises:
a power source;
a microprocessor connected to said power source; and
a transformer connected to said power source and said microprocessor, said transformer supplying electric shock to an animal when said microprocessor sends a signal thereto for indicating that an animal has wandered beyond a predetermined boundary.

3. The system of claim 2, wherein said notification means comprises electrical contacts connected to said transformer.

4. The system of claim 1, wherein said transmitting means comprises:
an antenna;
a transmitter connected to said antenna;
a microprocessor connected to said transmitter; and
a power source connected to said microprocessor.

5. The system of claim 1, wherein said potential means comprises:
an antenna wire;
a transmitter connected to said antenna wire;
a microprocessor connected to said transmitter; and
a potentiometer connected to said microprocessor.

6. The system of claim 1, wherein said locating means comprises:
a transmitter;
a CPU connected to said transmitter;
a wide area network connected to said CPU; and
a database connected to said CPU and for keeping track of a location of an animal.

7. The system of claim 1, wherein said portable fence unit comprises a housing having a general pyramid shape, said fence unit further includes a plurality of elongate antennas spaced apart from each other and extending outwardly from said housing.

8. An animal locating system comprising:
a collar unit including a wireless transceiver for selectively emitting encoded signals to identify when an animal has wandered beyond a predetermined boundary, said collar unit further including notification means communicating with said transceiver and for dissuading an animal from wandering beyond a predetermined boundary, said notification means includes
a power source,
a microprocessor connected to said power source, and
a transformer connected to said power source and said microprocessor, said transformer supplying electric shock to an animal when said microprocessor sends a signal thereto for indicating that an animal has wandered beyond a predetermined boundary;
said collar unit further including GPS means connected to said transceiver and for identifying a location of an animal after same has wandered beyond a predetermined boundary;
a portable remote unit including transmitting means for selectively sending an encoded signal to said collar unit and for notifying an animal that an undesired act has been performed;
a portable fence unit including potential means for determining the level of voltage to be supplied by said notification means to an animal, said portable fence unit being selectively positionable for determining a predetermined boundary within which an animal may wander; and
a third party service unit including locating means for communicating with said GPS means so that a location of an animal can be determined, said third party service unit communicating with said transceiver means for determining a location of an animal when same has wandered beyond a predetermined boundary.

9. The system of claim 8, wherein said notification means comprises electrical contacts connected to said transformer.

10. The system of claim 8, wherein said transmitting means comprises:
an antenna;
a transmitter connected to said antenna;
a microprocessor connected to said transmitter; and
a power source connected to said microprocessor.

11. The system of claim 8, wherein said potential means comprises:
an antenna wire;
a transmitter connected to said antenna wire;
a microprocessor connected to said transmitter; and
a potentiometer connected to said microprocessor.

12. The system of claim 8, wherein said locating means comprises:
a transmitter;
a CPU connected to said transmitter;
a wide area network connected to said CPU; and
a database connected to said CPU and for keeping track of a location of an animal.

13. The system of claim 8, wherein said portable fence unit comprises a housing having a general pyramid shape, said fence unit further includes a plurality of elongate antennas spaced apart from each other and extending outwardly from said housing.

14. An animal locating system comprising:
a collar unit including a wireless transceiver for selectively emitting encoded signals to identify when an animal has wandered beyond a predetermined boundary, said collar unit further including notification means communicating with said transceiver and for dissuading an animal from wandering beyond a predetermined boundary, said notification means includes
a power source,
a microprocessor connected to said power source, and
a transformer connected to said power source and said microprocessor, said transformer supplying electric shock to an animal when said microprocessor sends a signal thereto for indicating that an animal has wandered beyond a predetermined boundary;
said collar unit further including GPS means connected to said transceiver and for identifying a location of an animal after same has wandered beyond a predetermined boundary;
a portable remote unit including transmitting means for selectively sending an encoded signal to said collar unit and for notifying an animal that an undesired act has been performed;
a portable fence unit including a housing having a general pyramid shape, said fence unit further includes a plurality of elongate antennas spaced apart from each other and extending outwardly from said housing, said portable fence unit further includes potential means for determining the level of voltage to be supplied by said notification means to an animal, said portable fence unit being selectively positionable for determining a predetermined boundary within which an animal may wander; and
a third party service unit including locating means for communicating with said GPS means so that a location of an animal can be determined, said third party service unit communicating with said transceiver means for determining a location of an animal when same has wandered beyond a predetermined boundary.

15. The system of claim 14, wherein said notification means comprises electrical contacts connected to said transformer.

16. The system of claim 14, wherein said transmitting means comprises:
an antenna;
a transmitter connected to said antenna;
a microprocessor connected to said transmitter; and
a power source connected to said microprocessor.

17. The system of claim 14, wherein said potential means comprises:
an antenna wire;
a transmitter connected to said antenna wire;
a microprocessor connected to said transmitter; and
a potentiometer connected to said microprocessor.

18. The system of claim 14, wherein said locating means comprises:
a transmitter;
a CPU connected to said transmitter;
a wide area network connected to said CPU; and
a database connected to said. CPU and for keeping track of a location of an animal.
